(19) United States
(12) Patent Application Publication
(10) Pub. No.: US 2025/0344646 A1
(43) Pub. Date: Nov. 13, 2025

(54) COMPOUND MOTION SOIL BLOCKER

(71) Applicant: Johnny's Selected Seeds, Winslow, ME (US)

(72) Inventors: Graham Bowe, Langhorne, PA (US); Arthur Haines, Winthrop, ME (US); Bradford Waugh, Decatur, GA (US); Ronald DiGravio, Winthrop, ME (US)

(73) Assignee: Johnny's Selected Seeds, Winslow, ME (US)

(21) Appl. No.: 19/204,448

(22) Filed: May 9, 2025

Related U.S. Application Data
(60) Provisional application No. 63/645,652, filed on May 10, 2024.

(51) Int. Cl. A01G 9/029

(52) U.S. Cl. CPC A01G 9/0299; A01G 9/0297

(57) ABSTRACT

A compound motion soil blocker that uses mechanical advantage to reduce the force required to manually produce soil blocks. The blocker includes a primary structural frame, a control frame, an ejection arm set and a handle arm set. The soil blocker includes a toggle mechanism set coupling together the handle arm set and the ejection arm set to create a mechanical advantage such that the application of a minimal amount of manual pressure on the handle arm generates substantially more pressure on the ejection arm. The ejection arm is pinned to a compression structure including one or more plungers that are arranged to compress soil in a grid into soil blocks.

### BACKGROUND OF THE INVENTION

### 1. Field of the Invention

The present invention relates to a device that compresses dampened soil into small blocks for seed starting. More particularly, the present invention relates to consistently compressing soil within a grid to form a series of blocks in a seed starting tray ready for sowing seeds. Still more particularly, the present invention relates to a compound motion soil blocker, which utilizes a handle arm for mechanical advantage to form the seed starting blocks consistently and efficiently.

### 2. Description of the Prior Art

There currently exists several methods of seed starting. Thermoformed plastic trays are used to sow a multitude of seeds. Seed starting is performed by filling the plastic trays with soil, compressing the soil a bit by hand, and then sowing seeds into each cell within the plastic tray. The seeds then grow in the cell until they are ready for transplanting. The cells in the plastic tray support the soil, which is relatively loose, while the seed germinates and grows.

Alternatively, there are soil blockers available on the market that, instead of using cell trays, compress dampened soil into shapes such as uniform square or rectangle cubes, but not limited thereto, of soil blocks that are ready to accept seeds when the compressing process is completed. With soil blockers, there is no plastic tray needed to maintain the shape of the soil block while the seeds grow, and the soil blocks may be established on a flat tray or surface. Variations of these blocker devices can compress as few as four cells and as many 200 or more cells in one compression.

Existing soil blockers are designed with plungers, a mechanism for applying compressive load to soil using substantially uniform pressure on a portion or all of the plungers, and grids that prevent lateral spread of the soil while being compressed by the plungers. The grid includes a perimeter frame and set of dividers that form an array of cells for forming the soil blocks but is not maintained in position after the plunger pressure is released and the soil blocks have been formed. Once the dampened soil is compressed into the cells of the grid, the soil holds its shape in the form of the soil block after grid removal. The grid is typically made out of metal, such as sheet metal or stainless steel but not limited thereto, to maintain the shape of the block while the soil is under compression by the plungers under load. Plungers of different types may be used to generate a uniform load on the surface area of the soil within a cell or cells of the grid.

There currently exists in the marketplace a wide variety of soil blockers. They range from simple hand-held components used to load a single plunger, to a single array of load elements actuated in a single movement to transfer load substantially uniformly to some or all of the plungers in an array of plungers for engaging with soil in an array of frames of a grid. The existing soil blockers require the user to push the plungers onto the soil manually and by brute force or with some moderate assistance from a spring-loaded mechanism. There is essentially no mechanical advantage provided to the user operating manually the existing soil blockers. Manual operation of equipment is a standard of small-scale farming including small-scale commercial farming. The existing blocker devices are too difficult to operate manually to generate uniform, tightly compressed soil blocks for seedling growth on any sort of a commercial small-scale farm.

What is needed is a soil blocker capable of forming seed-growing soil cubes without the need for a plastic cell tray wherein the formed cubes are of substantially uniform shape that can be implemented in a commercial environment. The soil blocker should be reusable with consistent soil block formation after repeated contact with an underlying rigid substrate, such as the grid. The soil blocker should be configured to perform compression and ejection functions using a mechanical advantage to produce substantially uniform compressed soil blocks without requiring excessive physical exertion.

### SUMMARY OF THE INVENTION

The present invention is a compound motion soil blocker capable of forming seed-growing soil blocks that are of substantially uniform shape by utilizing mechanical advantage to perform the compression and ejection of the soil blocks. The compound motion soil blocker of the present invention can be implemented in a commercial farming environment to provide efficient manual block formation with less physical exertion than required when using prior block producing mechanisms.

The compound motion soil blocker of the present invention includes a primary structural frame and a secondary tray control frame used to align plungers with the frames of a grid on a seedling flat or tray. The plungers are first actuated by a compression structure that includes an ejection arm and a handle arm that are together arranged to apply a force to the plungers to compress soil in the grid. The plungers are actuated with the compression structure to generate a secondary motion to eject the soil blocks in the seedling flat or tray. The ejection arm and the handle arm are secured together at a common toggle mechanism. The handle arm is attached to a single plunger or an array of a plurality of plungers adjacent to the toggle mechanism. The handle arm is also attached to the primary structural frame to establish an ejection point as a component of the mechanical advantage.

When a manual force is applied to the handle arm, that force is multiplied by the common toggle mechanism linkage that engages with the control frame, which pushes the plungers. The plungers compress soil in the grid to form soil blocks. The user may continue to apply the compression force until reaching a travel limit between the ejection arm and the handle arm. When that travel limit is reached, the ejection arm pivots and the compressed soil blocks are ejected from the grid, which remains in a stationary position. That is, the mechanical advantage produced using the compound motion of the handle arm and the ejection arm actuates the toggle mechanism, thereby reducing the force that must be applied by the user, allowing for quicker and more efficient formation of soil blocks.

The compound motion soil blocking device uses mechanical advantage to perform compression and ejection functions to produce compressed soil blocks. The mechanical toggle mechanism linkage between the ejection arm and the handle arm acts as a force-multiplier greatly increasing the compression on soil with comparatively little force applied to the handle arm. The toggle mechanism is a combination of links, including a cam and a control frame. The linkages are connected to the handle arm and the ejection arm by pinned joints that are so arranged that a small force applied at one point can create a much larger force at another point. A cam on the toggle mechanism engages with the control frame when the tray and grid, filled with soil, have been loaded into the blocker of the present invention and primary motion of the handle arm and ejection arm compresses the soil by forcing the plungers into the soil. Compression is complete when adjacent ends of the handle arm and the ejection arm make contact with one another. With soil compression complete and the ejection and handle arms working as one straight arm, a secondary continuation motion then pushes the compressed soil through the stationary grid where the formed soil blocks and tray under the soil blocks drop away from the stationary grid retained on the primary structural frame. The toggle mechanism is disengaged when the handle arm is moved upwardly and the array of plungers move up and out of the way of the compression plane. This compound motion soil blocker allows growers to produce full trays of seed starting blocks in much less time and with less work than other soil blocking devices on the market today.

### BRIEF DESCRIPTION OF THE DRAWINGS

FIG. 1 is a front view of the compound motion soil blocker of the present invention.

FIG. 2 is a side view of the compound motion soil blocker.

FIG. 3 is a top view of the compound motion soil blocker.

FIG. 4 is a front perspective view of the compound motion soil blocker and showing soil in a seedling tray prior to compression.

FIG. 5 is the front perspective view of the compound motion soil blocker of FIG. 4 with the seedling tray under the compression structure prior to force application.

FIG. 6 is a front perspective view of the compound motion soil blocker with the cells of the seedling tray under compression.

FIG. 7 is a front perspective view of the compound motion soil blocker with the compression structure in an ejection position and showing the formed soil blocks in the tray.

FIG. 8 is a detailed side view of a portion of the compound motion soil blocker.

FIG. 9 is a side view of the compound motion soil blocker in partial phantom showing the toggle mechanism engaging the ejection arm and the handle arm.

### DETAILED DESCRIPTION OF THE INVENTION

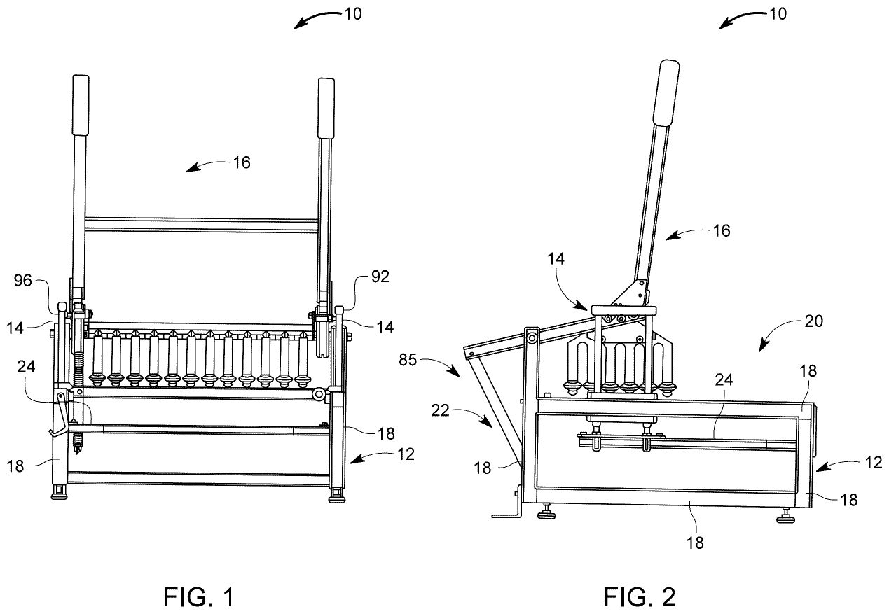

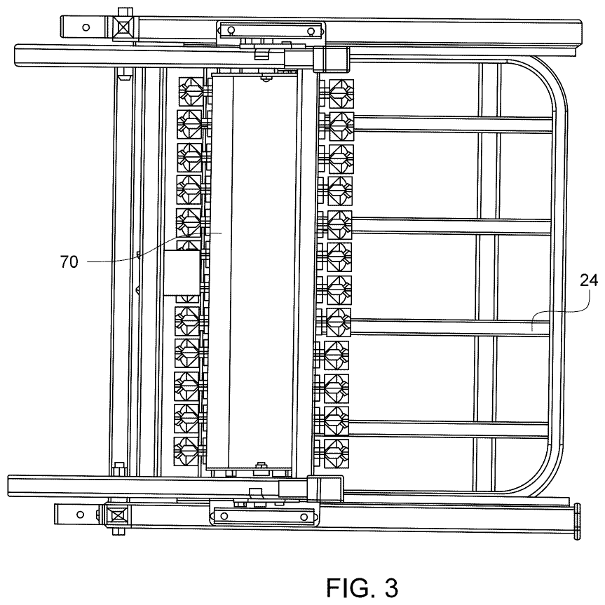

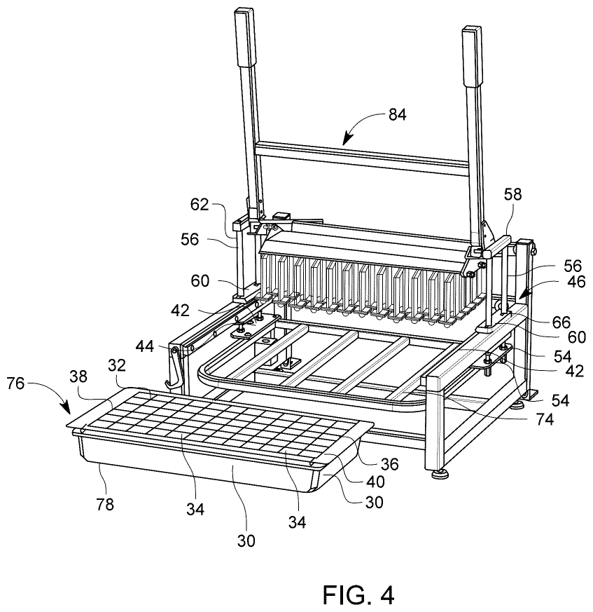

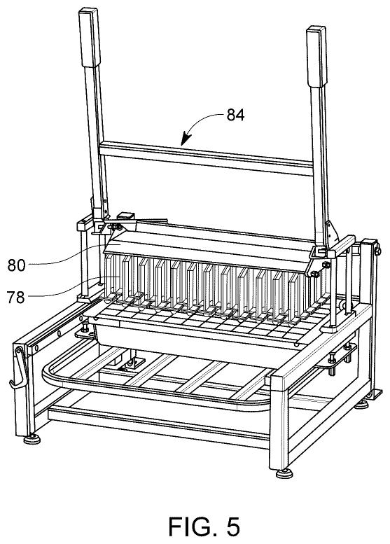

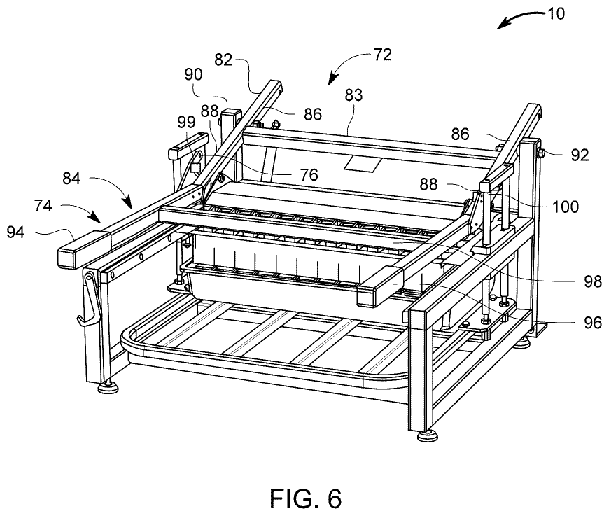

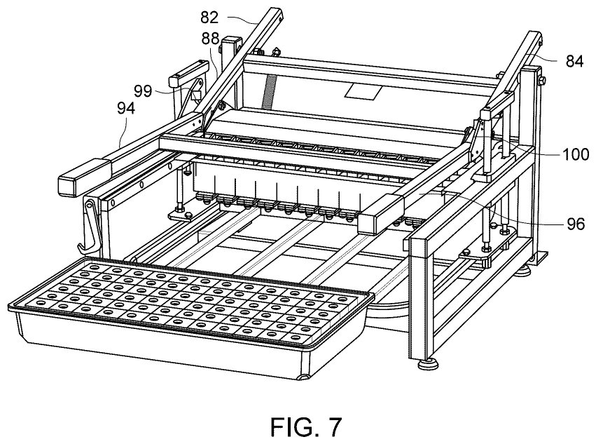

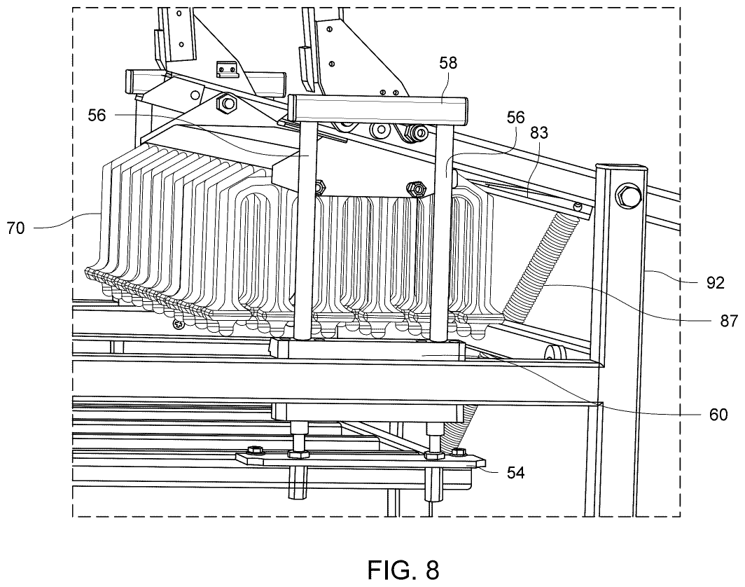

A compound motion soil blocker 10 of the present invention is shown in FIGS. 1-9. The blocker 10 includes a primary structural frame 12 and a movable secondary control frame 14 coupled to the primary structural frame 12. The secondary control frame 14 may also be referred to as a tray control frame and forms part of the toggle mechanism described in more detail herein. The blocker 10 further includes a compression structure 16 coupled to the primary structural frame 12 and the control frame 14.

The primary structural frame 12 includes structural frame members 18 that are joined together to provide structural support for other components of the blocker 10 and to provide a stable base for carrying out soil compression operations using the compression structure 16. The primary structural frame 12 is generally defined as having a front end 20 and a back end 22. The front end 20 includes a staging support 24 for retaining thereon a planting tray 26. The staging support 24 is fixedly attached to the frame members 18 and is formed of a plurality of fixed bars or angles but is not limited thereto.

The planting tray 26 includes a base 28 and sidewalls 30. A grid structure 32 including a plurality of block forming cells 34 may be positioned on the base 28 of the tray 26. Soil may be placed in the cells 34 while the tray 26 is on the staging support 24 in advance of compressing that soil using the compression structure 16. The grid structure 32 includes a grid frame 36 arranged to retain the forming cells 34 thereto. The grid frame 36 includes an upper perimeter structure 38 including lateral perimeter extensions 40. The extensions 40 extend beyond the sidewalls 30 of the tray 26. The extensions 40 are arranged to sit on shoulders 42 of the frame members 18 of the primary structural frame 12. The extensions 40 are not fixed to the frame members 18 but slide along upper surfaces 44 of the shoulders 42 when moving the tray 26 between the front end 20 and the back end 22 of the primary structural frame 12.

The secondary control frame 14 includes a movable tray support 46, first tray control element 48, and second tray control element 50. Each of the first tray control element 48 and the second tray control element 50 includes a tray support coupling bar 54, and a set of slide bars 56. The slide bars 56 are fixedly spaced from one another by an upper joiner 58 and a lower joiner 60. First end 62 of each slide bar 56 is fixedly joined to the upper joiner 58, and second end 64 of each slide bar 56 is fixedly joined to the tray support coupling bar 54. Each of the lower joiner 60 is fixedly joined to one of the frames 18 of the primary structural frame 12. The lower joiner 60 includes ports 66 associated with each slide bar 56. The ports 66 extend completely through the lower joiner 60 and the frame 18. The slide bars 56 are arranged to move downwardly when the tray 26 is on the movable tray support 46 and load is applied to the tray 26 with the compression structure 16 after forming soil blocks. The movable tray support 46 is arranged to move downwardly and upwardly.

The compression structure 16 includes a plunger system 70, an ejection arm set 72, a handle arm set 74, and a toggle mechanism set 76. The plunger system 70 includes a plurality of plungers 78, each of which is removably connected to plunger coupling cap 80 at an underside thereof. The ejection arm set 72 includes a first ejection arm 82 and a second ejection arm 84 connected to each other with ejection arm connector 83. The ejection arm connector 83 is coupled to spring set 85. The spring set 85 includes one or more springs 87, each having a first end coupled to the ejection arm connector 83 and a second end coupled to a horizontal bar of the structural frame 12. The spring set 85 provides tension for return of the compression structure 16 to a standing position after a force has been applied to soil contained in the tray 26.

Each ejection arm 82/84 includes an ejection arm body 86 and a toggle end 88. Each ejection arm 82/84 is also coupled to the plunger coupling cap 80 at the toggle end 88. The ejection arm body 86 of the first ejection arm 82 is connected to a first vertical leg 90 of one of the frames 18 of the primary frame structure 12, and the ejection arm body 86 of the second ejection arm 84 is connected to a second vertical leg 92 of another of the frames 18. The positioning of the first ejection arm 82 on the first vertical leg 90 and the positioning of the second ejection arm 84 on the second vertical leg 92 is selectable. The selection of the locations of the ejection arms 82 and 84 on the vertical legs 90 and 92 dictates the extent of mechanical advantage provided by the blocker 10 when the ejection arms 82 and 84 are moved with the handle arm set 74.

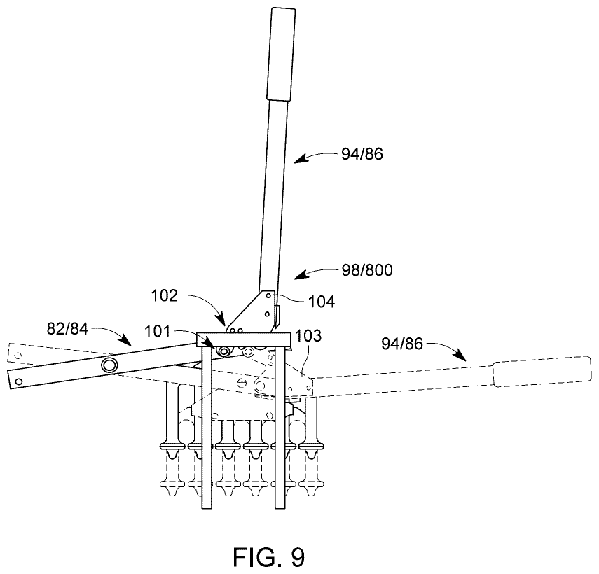

The handle arm set 84 includes a first handle arm 94, a second handle arm 96, and a handle arm joiner 98 for joining together, and spacing from one another, the first handle arm 94 and the second handle arm 96. The handle arm set 84 is connected to the ejection arm set 72 via the toggle mechanism set 76. Specifically, The first handle arm 94 is coupled to the first ejection arm 82 by first toggle mechanism 99, and the second handle arm 96 is coupled to the second ejection arm 84 by second toggle mechanism 100. Each of the first toggle mechanism 98 and the second toggle mechanism 100 includes a cam 101 and a bracket 103. The cam 101 and the bracket 103 establish a first toggle link 102 and a second toggle link 104 as shown in FIG. 9. The first toggle link 102 is coupled at a first end thereof to the toggle end 88 of the first ejection arm 82 and to a second end of the second toggle link 104, with both connections being pinned joints. The second toggle link 104 is coupled at a first end thereof to the second handle arm 96 to establish a pinned joint at that connection. With this configuration, the ejection arm set 72 and the handle arm set 74 are coupled together in such a way that engagement of the links 102 and 104 of the toggle mechanism set 76 enables easy and rapid compression of the soil in the cells 34 of the grid structure 32 with modest manual force applied to the handle arm set 74.

The mechanical toggle linkage of the toggle mechanism set 76 between the ejection arm set 72 and the handle arm set 74 acts as a force-multiplier greatly increasing the compression on soil with comparatively little force applied to the handle arm set 74. The toggle mechanism set 74 is engaged with the control frame 14 when the tray 26 and the grid structure 32, filled with soil, have been loaded into the blocker 10 and primary motion of the handle arm set 74 and ejection arm set 72 compresses the soil by forcing the plungers 78 into the soil. Compression is complete when adjacent ends of the handle arm set 74 and ejection arm set 72 make contact with one another. With soil compression complete and the ejection and handle arms working as one straight arm, a secondary continuation motion then pushes the compressed soil through the stationary grid structure 32 where formed soil blocks and the tray 26 under the soil blocks drop away from the stationary grid structure 32 retained on the primary structural frame 12. The toggle mechanism set 76 is disengaged when the handle arm set 74 is moved upwardly and the array of plungers 78 move up and out of the way of the compression plane.

FIG. 9 illustrates the interaction described herein among the toggle mechanism set 76, the ejection arm set 72, and the handle arm set 74.

While the present invention has been described with respect to specific configurations, it is not intended to be limited thereto.

What is claimed is:

1. A compound motion soil blocker comprising:
a primary structural frame;
a handle arm set;
an ejection arm set coupled to the primary structural frame and the handle arm set;
a plurality of plungers joined together by a joining body, wherein each plunger is configured to align with and fit into a cell of a grid located on a tray, and wherein the joining body is connected to the ejection arm set; and
a control frame;
wherein the handle arm set controls movement of the ejection arm set through a force-multiplying toggle mechanism set;
wherein movement of the ejection arm set controls the movement of the joining body; and
wherein the toggle mechanism set creates loading leverage on the plurality of plungers through mechanical advantage established between the handle arm set and the ejection arm set.

2. The compound motion soil blocker of claim 1 wherein the control frame includes a tray support surface.

3. The compound motion soil blocker of claim 1 wherein the force-multiplying toggle mechanism set includes a first toggle mechanism and a second toggle mechanism, wherein each of the first toggle mechanism and the second toggle mechanism includes a first toggle link and a second toggle link, wherein the first toggle link is pinned to the ejection arm set, the second toggle link is pinned to the handle arm set, and the first toggle link and the second toggle link are pinned together.

4. The soil blocker device of claim 1 wherein the main body, the upper section, the lower section, and the end cap of each plunger is made of a metal material.
